(19) United States
(12) Patent Application Publication
(10) Pub. No.: US 2022/0307773 A1
(43) Pub. Date: Sep. 29, 2022

(54) CONTROLLABLE PHASE CHANGE MATERIAL BAG AND PREPARATION METHOD THEREOF AND APPLICATION THEREOF

(71) Applicant: SOUTH CHINA UNIVERSITY OF TECHNOLOGY, Guangzhou (CN)

(72) Inventors: Lizhi ZHANG, Guangzhou (CN); Hong YU, Guangzhou (CN); Chuanshuai DONG, Guangzhou (CN)

(73) Assignee: SOUTH CHINA UNIVERSITY OF TECHNOLOGY, Guangzhou (CN)

(21) Appl. No.: 17/612,573

(22) PCT Filed: Oct. 28, 2019
(86) PCT No.: PCT/CN2019/113795

§ 371 Date: Nov. 19, 2021

(30) Foreign Application Priority Data
May 20, 2019 (CN) 201910420849.7

(51) Int. Cl. F28D 20/00; C09K 5/06

(52) U.S. Cl. CPC F28D 20/0034; C09K 5/063

(57) ABSTRACT

A controllable phase change material bag and a preparation method and an application thereof are provided. The preparation method comprises the following steps: 1, form a metal plate or a metal bar with a rough surface, embedding a powder seed crystal that induces a phase change material to nucleate on the surface, then placing the metal plate or the metal bar in a sodium acetate solution to obtain a controllable trigger metal electrode (1); and 2, mixing a sodium acetate trihydrate crystal, water and a thickener to obtain an oversaturated phase change heat storage solution, pouring the solution into a metal ball (2), carrying out encapsulation after inserting the controllable trigger metal electrode obtained in the step 1 and a conducting electrode (3), and finally placing in the water bath to preserve heat to obtain the controllable phase change material bag.

### BACKGROUND

### Technical Field

The present invention relates to the technical field of phase change heat storage materials, and in particular relates to a controllable phase change material bag and a preparation method thereof and an application thereof.

### Description of Related Art

A total solar radiation amount received annually in ⅔ of national territorial area of China exceeds 5000 J/m² with an annual sunshine duration of longer than 2000 h, and it has a huge solar energy utilization potential. However, as solar energy has shortcomings of intermittence, circadian periodicity and seasonality, utilization thereof is limited to a certain extent. An energy storage technology becomes an efficient path that utilizes energy sources reasonably and alleviates environmental pollution as it can solve the problem that supply and demand of heat energy are mismatched in time and space.

Conventional heat energy storage is sensible heat storage of a water tank, which is the most extensive heat storage mode applied at present. However, in this way, a heat storage density is small, temperature changes in heat absorbing and heat releasing processes are relatively large, and controllability is poor. In comparison, the heat storage density storing heat by applying the phase change latent heat is 5-10 times or higher of heat storage by sensible heat, and meanwhile, the phase change heat storage material further features in relatively constant phase change temperature, stable heat storage and release temperature of a heat accumulator and easy control and the like, so that it becomes a research hotspot in recent years.

A phase change heat storage technology stores and releases energy by heat absorption/release of phase change materials (PCMs) in solid-solid and solid-liquid phase change processes, so that an absorbent relation of energy supply and energy consumption in time and space is further reconciled, thereby realizing energy conservation and comprehensive gradient utilization. Phase change materials can be divided into organic phase change materials (paraffin, fatty acids and the like), inorganic phase change materials (hydrous salts and metals) and composite phase change materials. The inorganic phase change materials featuring in large heat storage density, low price, wide source, moderate phase change temperature and the like are widely applied in the fields of solar energy, industry, agriculture, building industry and the like. Sodium acetate trihydrate (CH₃COONa.3H₂O) is a typical inorganic hydrous salt phase change heat storage material with a melting point of 58° C., and it has advantages of higher melting heat (265 kJ/kg), good heat conductivity, non-toxicity, low price, wide source and the like, so that it becomes a very potential heat storage material in medium and low temperature phase change heat storage materials.

However, there is a critical general problem in an application process of the hydrous salt as the phase change energy storage material, i.e., supercooling and phase separation. Heat stored by the phase change material transited from a crystal phase to a liquid state cannot be released in the presence of supercooling and phase separation, so that the heat storage amount of a heat storage system is decreased. Researches performed by most researches on the phase change material at present focus on improving conditions of phase separation and degree of supercooling of the phase change material by mainly adding a thickener and a nucleating agent.

A Chinese invention patent CN108219753A provides a preparation method and an application of a spontaneous heating bag. The spontaneous heating bag is primarily composed of a phase change material and a metal sheet. The phase change material in a supercooling state is not crystallized spontaneously and it is necessary to break the metal sheet with hands to release a seed crystal in a metal gap to trigger nucleation, which is a controllable nucleating manner. However, it is necessary to break the metal sheet with hands in this manner. Therefore, the phase change material only can be encapsulated in a relatively small soft plastic bag capable of touching a metal sheet inside for releasing heat in a small range. It is merely applied to the field of local physical therapy and health and fitness, and is hard to store and release heat in a large scale system and a large area such as solar energy, which application is limited. Therefore, it is of quite important significance to provide a simple and easily operated controllable storage and release method capable of being suitable for heat such as solar energy.

### SUMMARY

### Technical Problem

### The Problem of the Technical Solution

### Technical Solution

By overcoming deficiencies and defects in the prior art, an objective of the present invention is to provide a controllable phase change material bag and a preparation method and an application thereof.

The objective of the present invention is at least realized by one of the technical solutions as follows.

A preparation method of a controllable phase change material bag includes the following preparation steps.

(1) carrying out a surface treatment on a metal plate or a metal bar to form a metal plate with a rough surface or a metal bar with a rough surface, embedding a powder seed crystal that induces a phase change material to nucleate on the rough surface of the metal plate or the rough surface of the metal bar, then placing the metal plate or the metal bar carrying the powder seed crystal in a sodium acetate solution and placing the sodium acetate solution in a water bath to preserve heat to obtain a controllable trigger metal electrode.

(2) mixing the phase change material with a sodium acetate trihydrate crystal, water and a thickener to form a mixture, carrying out a water bath heating and a stirring till the mixture is fully dissolved to obtain an oversaturated phase change heat storage solution, pouring the solution into a stainless steel metal ball, carrying out an encapsulation after inserting the controllable trigger metal electrode obtained in the step (1) and a conducting electrode, and finally placing the steel metal ball in the water bath to preserve heat to obtain the controllable phase change material bag.

Further, in the step (1), the surface treatment is sanding by an abrasive paper or notching by a cutting tool, and the abrasive paper is 80 to 1200 meshes. For example, the surface of the metal is polished with 80-mesh abrasive paper first, the powder seed crystal is embedded, then the surface of the metal is polished with 320-mesh abrasive paper, the powder seed crystal is embedded, and the surface of the metal is polished smoothly with 1200-mesh abrasive paper. A tool used for a scratch of a cutting point is a cutting tool, and the powder seed crystal is embedded at a scratch opening.

Further, the power seed crystal in the step (1) is a power seed crystal formed by grinding a sodium acetate trihydrate crystal.

Further, in the step (2), a mass fraction of the sodium acetate trihydrate crystal is 73.5% to 91%, a mass fraction of the water is 8.5% to 24.5% and a mass fraction of the thickener is 0.5% to 2%.

Further, a heating temperature in the water bath in the step (2) is 70° C. to 80° C., a heat preservation temperature in the water bath is 70° C. to 80° C., and a heat preservation time is 1 hour to 2 hours.

Further, in the step (1), the metal electrode is immersed in the sodium acetate solution after the surface of the metal electrode is coated with the powder seed crystal and the sodium acetate solution is placed in the constant temperature water batch at 70° C. to 80° C., and the temperature is preserved for 1 hour to 2 hours, so that excessive seed crystals on the surface of the electrode are removed.

Further, a material of the controllable trigger metal electrode is silver or copper, the thickener is carboxymethylcellulose or sodium polyacrylate, and the conducting electrode is a graphite electrode.

With respective to the controllable phase change material bag obtained by the above preparation method, a voltage is applied between the controllable trigger electrodes to trigger the oversaturated phase change heat storage solution to change the phase and release heat, and the voltage ranges from 0.5 V to 1.8 V.

The controllable phase change material bag can realize controllable heat release and absorption of the phase change material, can be applied to civil life such as waste heat recovery of solar energy, a heat pump, a water heater or a boiler, and can be widely applied to the fields of other low grade waste heat recovery, seasonal heat storage and the like.

A working principle of the controllable phase change material bag of the present invention is as follows: under a high-temperature condition, a high concentration oversaturated phase change heat storage solution is not crystallized spontaneously at a relatively low temperature, and still exists in form of a liquid state, and heat is stored by way of latent heat. When a small voltage is applied between processed electrodes, controllable occurrence of a phase change process can be realized, and the scope of the applied voltage ranges from 0.5 V to 1.8 V.

### Beneficial Effects of the Present Invention

### Beneficial Effects

Compared with the prior art, the present invention has the following beneficial effects.

(1) The present invention realizes controllable release of heat stored by the room temperature supercooling solution by means of an inherent supercooling defect of the inorganic phase change material.

(2) The preparation method of the present invention is simple, controllable and easy to operate, with simple preparation process, short in production period and low in cost; and controllable release of heat stored by the phase change material can be realized by applying a small voltage (0.5 V to 1.8 V) in the phase change material.

(3) The present invention can be applied to a solar heat pump hot water system as a heat storage/release unit to play roles in energy saving and emission reducing.

(4) Materials used by the present invention are non-toxic, free of corrosion and free of pollution.

### BRIEF DESCRIPTION OF THE DRAWINGS

### Description of the Drawings

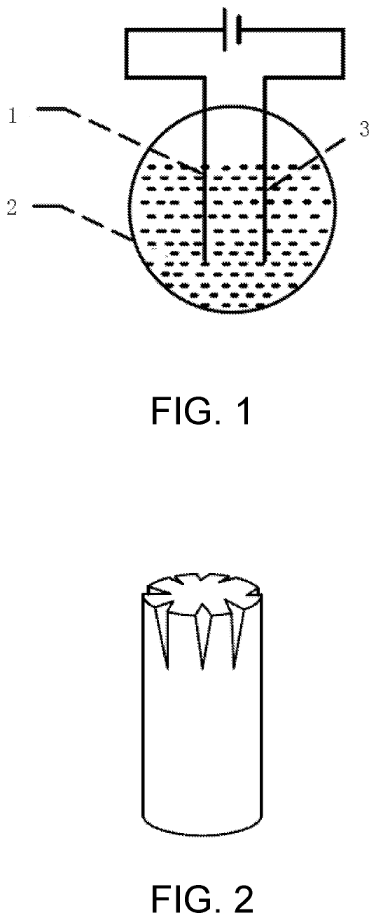

FIG. 1 is a schematic diagram of a phase change heat storage apparatus of a controllable phase change material bag prepared by the present invention.

FIG. 2 is a schematic diagram of an edge shape of a metal electrode treated by a scratch of a cutting tool in Embodiment 2.

### DESCRIPTION OF THE EMBODIMENTS

### Embodiments of the Present Invention

In order to better understand the present invention, the content of the present invention is further illustrated below in combination with embodiments, but the content of the present invention is not limited to the embodiments below.

### Embodiment 1

A method for preparing a controllable phase change material bag includes the following preparation steps.

(1) A sodium acetate trihydrate crystal is placed in a mortar and is ground into power for later use; a silver filament electrode is taken, a surface of the silver filament electrode is polished with 80-mesh abrasive paper, and the surface is coated with the ground powder; then the surface is polished with 320-mesh abrasive paper, and the surface is coated with the powder; the surface is polished with 1200-mesh abrasive paper again, the sodium acetate trihydrate powder is coated to the surface, and an electrode carrying a powder seed crystal is placed in a sodium acetate solution in a water bath at 75° C. to preserve heat for 2 hours to obtain a controllable trigger metal electrode 1.

(2) 82.2% of sodium acetate trihydrate, 16.8% of water and 1% of carboxymethylcellulose are weighed in percent by mass and filled in a beaker, and components are stirred in a water bath at 75° C. till the components are fully dissolved to obtain an oversaturated phase change heat storage solution; and the prepared solution is poured into a stainless steel ball 2 while it is hot, then the metal electrode prepared in the step (1) and a graphite rod electrode 3 are inserted into the oversaturated phase change heat storage solution, and it is sealed and is subject to heat preservation at 75° C. in the water bath for 2 hours to obtain the controllable phase change material bag, as shown in FIG. 1.

After the controllable phase change material bag prepared in the present embodiment is cooled to room temperature, and the phase change material is triggered to crystallize and release heat within 5 s by applying a 1V voltage between the anodic metal silver electrode and the cathodic graphite rod electrode. It only takes about 12 minutes for 20 ml of room temperature crystals to store heat again in the water bath at 75° C. and completely change into a solution, so that a cycle period is short, cyclicity is good and attenuation is slow.

### Embodiment 2

A method for preparing a controllable phase change material bag includes the following preparation steps.

(1) A sodium acetate trihydrate crystal is placed in a mortar and is ground into power for later use; a copper filament electrode is taken, a scratch is scratched at a tail end of the electrode with a knife, the scratch at the tail end of the copper filament rod is coated with the ground powder, and then the metal electrode is placed in a sodium acetate solution to preserve heat in a 70° C. water bath for 1 hour to obtain a controllable trigger metal electrode, as shown in FIG. 2.

(2) 91% of sodium acetate trihydrate, 8.5% of water and 0.5% of carboxymethylcellulose are weighed in percent by mass, and components are stirred in a water bath at 80° C. till the components are fully dissolved to obtain an oversaturated phase change heat storage solution; and the prepared solution is poured into a stainless steel ball while it is hot, then the above pre-treated metal electrode and a graphite rod electrode are inserted into the oversaturated phase change heat storage solution, and it is sealed and is subject to heat preservation at 70° C. in the water bath for 2 hours to obtain the controllable phase change material bag.

After the controllable phase change material bag prepared in the present embodiment is cooled to room temperature, and the phase change material is triggered to crystallize and release heat within 5 s by applying a 1.8 V voltage between the anodic metal copper electrode and the cathodic graphite rod electrode. It only takes about 12 minutes for 20 ml of room temperature crystals to store heat again in the water bath at 75° C. and completely change into a solution, so that a cycle period is short, and cyclicity is good.

### Embodiment 3

A method for preparing a controllable phase change material bag includes the following preparation steps.

(1) A sodium acetate trihydrate crystal is placed in a mortar and is ground into power for later use; a silver filament electrode is taken, a scratch is scratched at a tail end of the electrode with a knife, the scratch at the tail end of the silver filament rod is coated with the ground powder, and then the silver filament electrode is placed in a sodium acetate solution to preserve heat in a 75° C. water bath for 2 hours to obtain a controllable trigger metal electrode.

(2) 73.5% of sodium acetate trihydrate, 24.5% of water and 2% of sodium polyacrylate are weighed in percent by mass, and components are stirred in a water bath at 70° C. till the components are fully dissolved to obtain an oversaturated phase change heat storage solution; and the prepared solution is poured into a stainless steel ball while it is hot, then the above pre-treated metal electrode and a graphite rod electrode are inserted into the oversaturated phase change heat storage solution, and it is sealed and is subject to heat preservation at 75° C. in the water bath for 2 hours to obtain the controllable phase change material bag.

After the controllable phase change material bag prepared in the present embodiment is cooled to room temperature, and the phase change material is triggered to crystallize and release heat within 5 s by applying a 0.5 V small voltage between the anodic metal silver electrode and the cathodic graphite rod electrode. It only takes about 12 minutes for 20 ml of room temperature crystals to store heat again in the water bath at 75° C. and completely change into a solution, so that a cycle period is short, cyclicity is good and attenuation is slow.

### Embodiment 4

A method for preparing a controllable phase change material bag includes the following preparation steps.

(1) A sodium acetate trihydrate crystal is placed in a mortar and is ground into power for later use; a silver plate electrode is taken, a surface of the silver plate electrode is polished with 80-mesh abrasive paper, and the surface is coated with the ground powder; then the surface is polished with 320-mesh abrasive paper, and the surface is coated with the powder; the surface is polished with 1200-mesh abrasive paper again, the sodium acetate trihydrate powder is coated to the surface, and an electrode carrying the powder seed crystal is placed in a sodium acetate solution in a 80° C. water bath to preserve heat for 1 hour to obtain a controllable trigger metal electrode.

(2) 73.5% of sodium acetate trihydrate, 24.5% of water and 2% of carboxymethylcellulose are weighed in percent by mass, and components are stirred in a water bath at 80° C. till the components are fully dissolved to obtain an oversaturated phase change heat storage solution; and then the above pre-prepared silver plate electrode and a graphite rod electrode are inserted into the oversaturated phase change heat storage solution, and it is sealed and is subject to heat preservation at 80° C. in the water bath for 1 hour to obtain the controllable phase change material bag.

After the controllable phase change material bag prepared in the present embodiment is cooled to room temperature, and the phase change material is triggered to crystallize and release heat within 5 s by applying a 0.8 V voltage between the anodic metal silver electrode and the cathodic graphite rod electrode. It only takes about 12 minutes for 20 ml of room temperature crystals to store heat again in the water bath at 75° C. and completely change into a solution. It can be recycled to use, with slow attenuation and good cyclicity.

### Embodiment 5

A method for preparing a controllable phase change material bag includes the following preparation steps.

(1) A sodium acetate trihydrate crystal is placed in a mortar and is ground into power for later use; a copper plate electrode is taken, a scratch is scratched at the copper plate electrode with a cutting tool, the scratch is coated with the ground powder, and then the electrode is placed in a sodium acetate solution to preserve temperature in a 70° C. water bath for 2 hours to obtain a controllable triggered electrode.

82.2% of sodium acetate trihydrate, 16.8% of water and 1% of sodium polyacrylate are weighed in percent by mass, and components are stirred in a water bath at 75° C. till the components are fully dissolved to obtain an oversaturated phase change heat storage solution; and then the above pre-prepared copper plate electrode and a graphite rod electrode are inserted into the oversaturated phase change heat storage solution, and it is sealed and is subject to heat preservation at 70° C. in the water bath for 2 hour to obtain the controllable phase change material bag.

After the controllable phase change material bag prepared in the present embodiment is cooled to room temperature, and the phase change material is triggered to crystallize and release heat within 5 s by applying a 1.6V voltage between the anodic metal copper plate electrode and the cathodic graphite rod electrode. It only takes about 12 minutes for 20 ml of room temperature crystals to store heat again in the 70° C. water bath and completely change into a solution. It can be recycled to use, with good cyclicity.

### Embodiment 6

A method for preparing a controllable phase change material bag includes the following preparation steps.

(1) A sodium acetate trihydrate crystal is placed in a mortar and is ground into power for later use; a silver plate electrode is taken, a scratch is scratched at the silver plate electrode with a cutting tool, the scratch is coated with the ground powder, and then the electrode is placed in a sodium acetate solution to preserve heat in a 80° C. water bath for 1 hours to obtain a controllable trigger metal electrode.

91% of sodium acetate trihydrate, 8.5% of water and 0.5% of sodium polyacrylate are weighed in percent by mass, and components are stirred in a water bath at 70° C. till the components are fully dissolved to obtain an oversaturated phase change heat storage solution; and then the above pre-prepared silver plate electrode and a graphite rod electrode are inserted into the oversaturated phase change heat storage solution, and it is sealed and is subject to heat preservation at 80° C. in the water bath for 1 hour to obtain the controllable phase change material bag.

After the controllable phase change material bag prepared in the embodiment is cooled to room temperature, and the phase change material is triggered to crystallize and release heat within 5 s by applying a 1.2 V voltage between the anodic metal silver plate electrode and the cathodic graphite rod electrode. It only takes about 12 minutes for 20 ml of room temperature crystals to store heat again in the water bath at 75° C. and completely change into a solution, so that a cycle period is short, cyclicity is good, and attenuation is slow.

The embodiments are preferred modes of execution of the present invention. The modes of execution of the present invention are not limited by the embodiments. Any other changes, modifications, substitutions, combinations and simplifications made without departing from the spirit and principle of the present invention shall be equivalent substitute modes and shall come within the protection scope of the present invention.

1. A preparation method of a controllable phase change material bag, comprising the following preparation steps:
step 1, carrying out a surface treatment on a metal plate or a metal bar to form a metal plate with a rough surface or a metal bar with a rough surface, embedding a powder seed crystal that induces a phase change material to nucleate on the rough surface of the metal plate or the rough surface of the metal bar, then placing the metal plate or the metal bar carrying the power seed crystal in a sodium acetate solution and placing the sodium acetate solution in a water bath to preserve heat to obtain a controllable trigger metal electrode (1); and
step 2, mixing the phase change material with a sodium acetate trihydrate crystal, water and a thickener to form a mixture, carrying out a water bath heating and a stirring till the mixture is fully dissolved to obtain an oversaturated phase change heat storage solution, pouring the solution into a stainless steel metal ball (2), carrying out an encapsulation after inserting the controllable trigger metal electrode (1) obtained in the step 1 and a conducting electrode (3), and finally placing the steel metal ball in the water bath to preserve heat to obtain the controllable phase change material bag.

2. The preparation method according to claim 1, wherein in the step 1, the surface treatment is sanding by an abrasive paper or notching by a cutting tool, and the abrasive paper is 80-1200 meshes.

3. The preparation method according to claim 1, wherein the powder seed crystal in the step 1 is a powder seed crystal formed by grinding a sodium acetate trihydrate crystal.

4. The preparation method according to claim 1, wherein a heat preservation temperature of the water bath in the step 1 is 70° C. to 80° C. and a heat preservation time is 1 hour to 2 hours.

5. The preparation method according to claim 1, wherein in the step 2, a mass fraction of the sodium acetate trihydrate crystal is 73.5 wt % to 91 wt %, a mass fraction of the water is 8.5 wt % to 24.5 wt % and a mass fraction of the thickener is 0.5 wt % to 2 wt %.

6. The preparation method according to claim 1, wherein a heating temperature in the water bath in the step 2 is 70° C. to 80° C., a heat preservation temperature in the water bath is 70° C. to 80° C., and a heat preservation time is 1 hour to 2 hours.

7. The preparation method according to claim 1, wherein a material of the controllable trigger metal electrode (1) is silver or copper, the conducting electrode (3) is a graphite electrode, and the thickener is carboxymethylcellulose or sodium polyacrylate.

8. A controllable phase change material bag obtained by the preparation method according to claim 1.

9. The controllable phase change material bag according to claim 8, wherein a voltage is applied between the controllable trigger electrodes to trigger the oversaturated phase change heat storage solution to change the phase and release heat, and the voltage ranges from 0.5 V to 1.8 V.

10. A use of the controllable phase change material bag according to claim 8 in waste heat recovery of solar energy, a heat pump, a water heater or a boiler.

11. A controllable phase change material bag obtained by the preparation method according to claim 2.

12. A controllable phase change material bag obtained by the preparation method according to claim 3.

13. A controllable phase change material bag obtained by the preparation method according to claim 4.

14. A controllable phase change material bag obtained by the preparation method according to claim 5.

15. A controllable phase change material bag obtained by the preparation method according to claim 6.

16. A controllable phase change material bag obtained by the preparation method according to claim 7.

17. A use of the controllable phase change material bag according to claim 9 in waste heat recovery of solar energy, a heat pump, a water heater or a boiler.
